(19) United States
(12) Patent Application Publication
(10) Pub. No.: US 2017/0019137 A1
(43) Pub. Date: Jan. 19, 2017

(54) DEVICE WITH VARIABLE FREQUENCY FILTER FOR REJECTING HARMONICS

(71) Applicant: CAVENDISH KINETICS, INC., San Jose, CA (US)

(72) Inventors: Ray PARKHURST, Santa Clara, CA (US); Roberto GADDI, 's-Hertogenbosch (NL)

(73) Assignee: CAVENDISH KINETICS, INC., San Jose, CA (US)

(21) Appl. No.: 15/301,262

(22) PCT Filed: Apr. 2, 2015
(86) PCT No.: PCT/US2015/024104

§ 371 Date: Sep. 30, 2016

Related U.S. Application Data
(60) Provisional application No. 61/976,466, filed on Apr. 7, 2014.

(51) Int. Cl. H04B 1/12; H04B 1/18; H04B 1/04

(52) U.S. Cl. CPC H04B 1/123; H04B 1/0458; H04B 1/18

(57) ABSTRACT

The present disclosure generally relates to a device having a variable frequency filter that rejects harmonics generated by a variable reactance device. The variable frequency filter may be coupled to the antenna and the variable reactance device. The filter includes a variable capacitor and an inductor coupled together as a resonant circuit. The filter may be used in cellular technology to prevent harmonic frequencies that are created by another variable reactance device from reaching the antenna of the cellular device. Furthermore, the filter can reflect any receiving frequencies from the antenna and prevent the receiving frequencies from passing through.

### BACKGROUND OF THE DISCLOSURE

Field of the Disclosure

Embodiments of the present disclosure generally relate to a device, such as a cell phone, with a filter to reject harmonics generated by a variable reactance device.

Description of the Related Art

Cellular phones, such as mobile phones, have many desirable features that make everyday life easier. For instance, mobile phones can receive emails, text messages and other data for the end user to utilize. Additionally, the mobile phone can send emails, text messages and other data from the mobile phone. The mobile phone typically operates on a wireless network provided by any one of the various cell phone carriers. The data sent to and from the mobile phones require the mobile phone to operate at an increasing number of frequencies to support all of the components and antennas of the mobile phone.

A variable reactance device may be used to tune the antennas of the mobile phone. By tuning the antenna, the mobile phone can more easily receive and send data. However, because of the numerous frequencies used, there can be undesired consequences such as undesired harmonics flowing from the variable reactance device to the antenna, and desired receive signals flowing from antenna to variable reactance device, that may negatively impact the performance of the mobile phone,

Therefore, there is a need in the art to prevent undesired harmonics from flowing between the antenna and variable reactance device and to isolate the variable reactance device from desired receive signals,

### SUMMARY OF THE DISCLOSURE

The present disclosure generally relates to a device having a variable frequency filter that rejects harmonics generated by a variable reactance device. The variable frequency filter may be coupled to the antenna and the variable reactance device. The filter includes a variable capacitor and an inductor coupled together as a resonant circuit. The filter may be used in cellular technology to prevent harmonic frequencies that are created by another variable reactance device from reaching the antenna of the cellular device. Furthermore, the filter can reflect any receiving frequencies from the antenna and prevent the receiving frequencies from passing through.

In one embodiment, a device comprises an antenna; an RF source coupled to the antenna; a variable reactance device coupled to the antenna; and a first variable frequency filter coupled to the antenna and the variable reactance device.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is an isometric illustration of a mobile phone according to one embodiment.

FIG. 2A is a schematic top illustration of a digital variable capacitor according to one embodiment.

FIG. 2B is a schematic cross-sectional illustration taken along line A-A of FIG. 2A.

FIGS. 3A-3E are schematic circuit diagrams of the device containing the variable frequency filter according to several embodiments.

FIGS. 4A-4E are schematic circuit diagrams of the device containing a variable frequency filter according to several additional embodiments.

FIGS. 5A-5C are schematic illustrations of a variable reactance device according to several embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure generally relates to a device having a variable frequency filter that rejects harmonics generated by a variable reactance device. The variable frequency filter may be coupled to the antenna and the variable reactance device. The filter includes a variable capacitor and an inductor coupled together as a resonant circuit. The filter may be used in cellular technology to prevent harmonic frequencies that are created by another variable reactance device from reaching the antenna of the cellular device. Furthermore, the filter can reflect any receiving frequencies from the antenna and prevent the receiving frequencies from passing through.

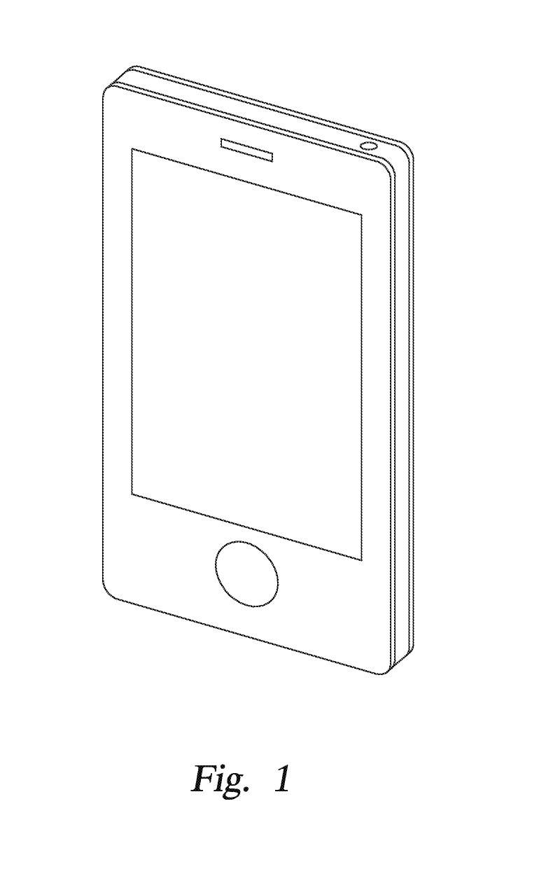

Small antennas which are suitable to be integrated in a portable radio frequency device such as the mobile phone illustration in FIG. 1 are typically mounted on the top side or the back side of the mobile device, and the device acts as an active counter pole of the antenna. Such small antennas are typically designed as variations of a simple monopole antenna, using forms such as (planar) inverted F antenna (P)IFA. The pattern of such antennas can be modified in order to adapt to the mechanical constraints of the device while maintaining the device's radiating characteristics.

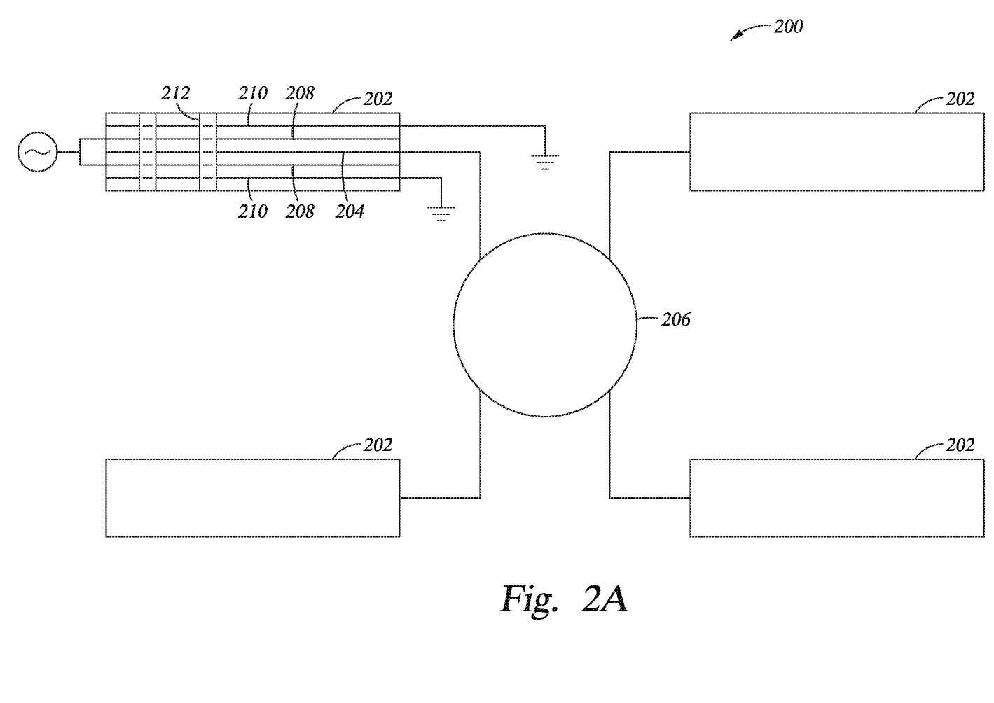

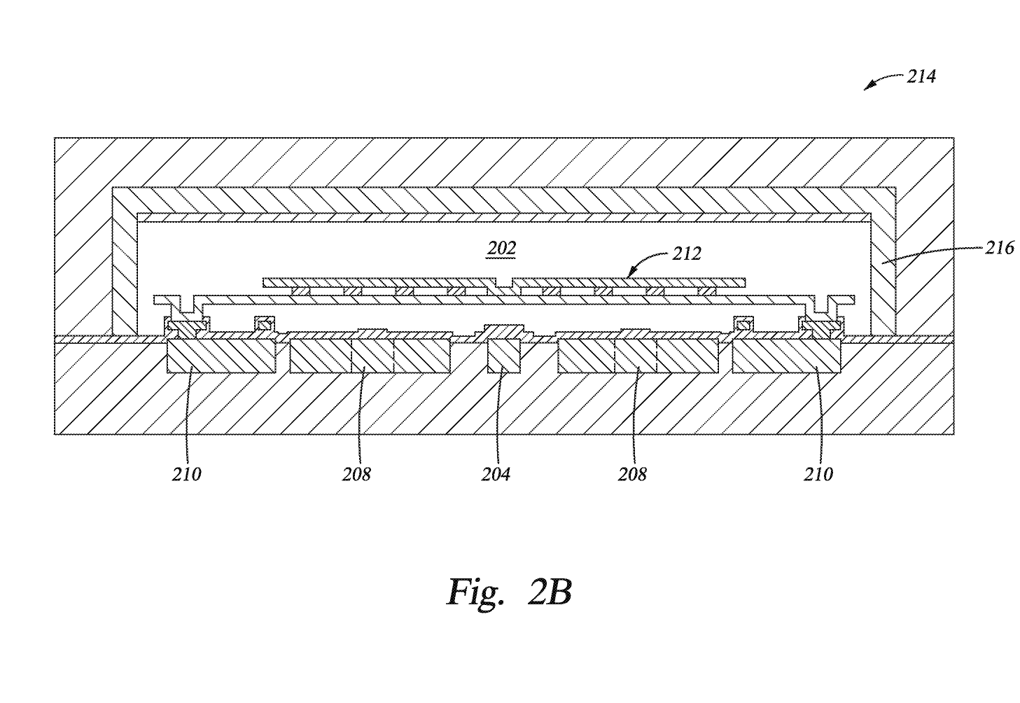

FIG. 2A is a schematic illustration of a digital variable capacitor (DVC) 200 according to one embodiment. The DVC 200 includes a plurality of cavities 202. While only one cavity 202 is shown in detail, it is to be understood that each cavity 202 may have a similar configuration, although the capacitance for each cavity 202 may be different.

Each cavity 202 has a RF electrode 204 which is coupled to an RF connector/solder bump 206. Additionally, each cavity 202 has one or more pull-in electrodes 208 and one or more ground electrodes 210. The switching elements 212 (2 shown) are disposed over the electrodes 204, 208, 210. In fact, the switching elements 212 are electrically coupled to the ground electrodes 210. The switching elements 212 are movable to various spacing from the RF electrode 204 due to electrically current applied to the pull-in electrodes 208.

FIG. 2B is a schematic illustration of a MEMS device 214. The MEMS device 214 includes the electrodes 204, 208, 210 and the switching element 212 which is disposed in the cavity 200 and movable from a position close to the RF electrode 204 (referred to as the Cₘₐₓ position) and a position spaced adjacent a pull-up electrode 216 (referred to as the Cₘᵢₙ position), The position of the switching elements 212 within the cavity 200 determines the capacitance for a particular cavity. By using the MEMS devices in a DVC, the antennas can be tuned as discussed herein.

The DVC 200 may be used to tune the antenna in the mobile phone. However, as noted above, undesired harmonics may be generated that need to be isolated from the antenna when flowing from the DVC. Also, receive signals may be present which need to be isolated from the DVC when flowing from the antenna. As such, a variable frequency filter may be used.

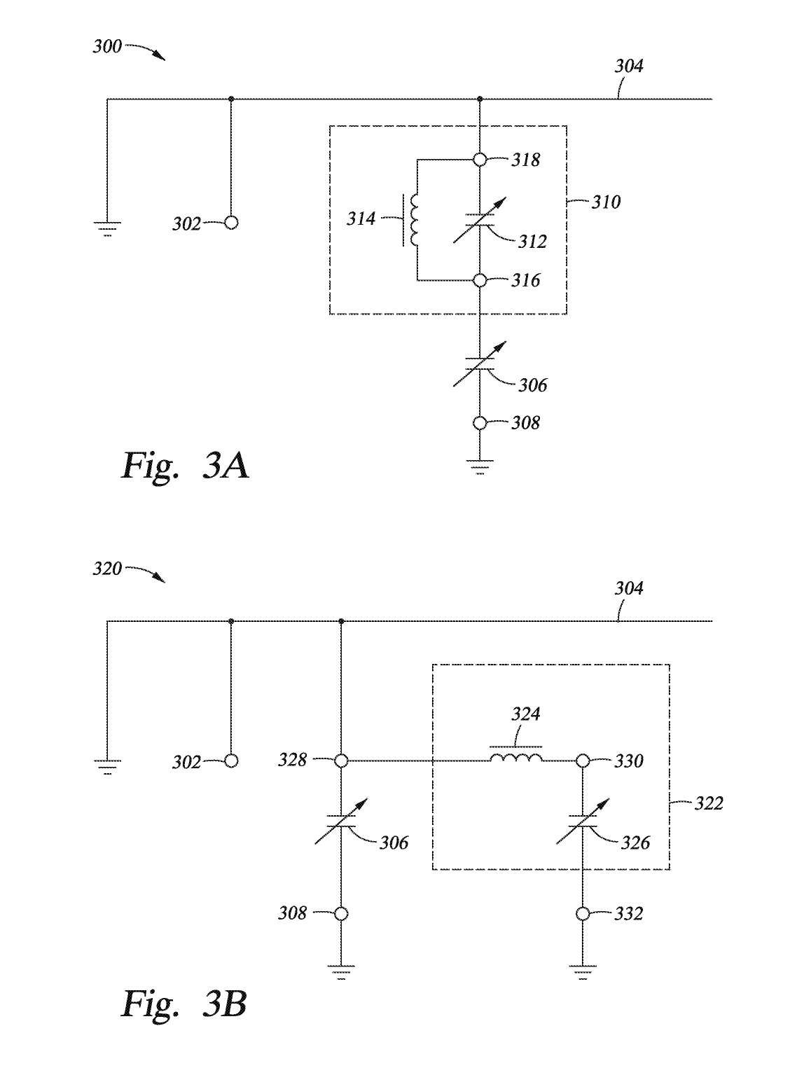

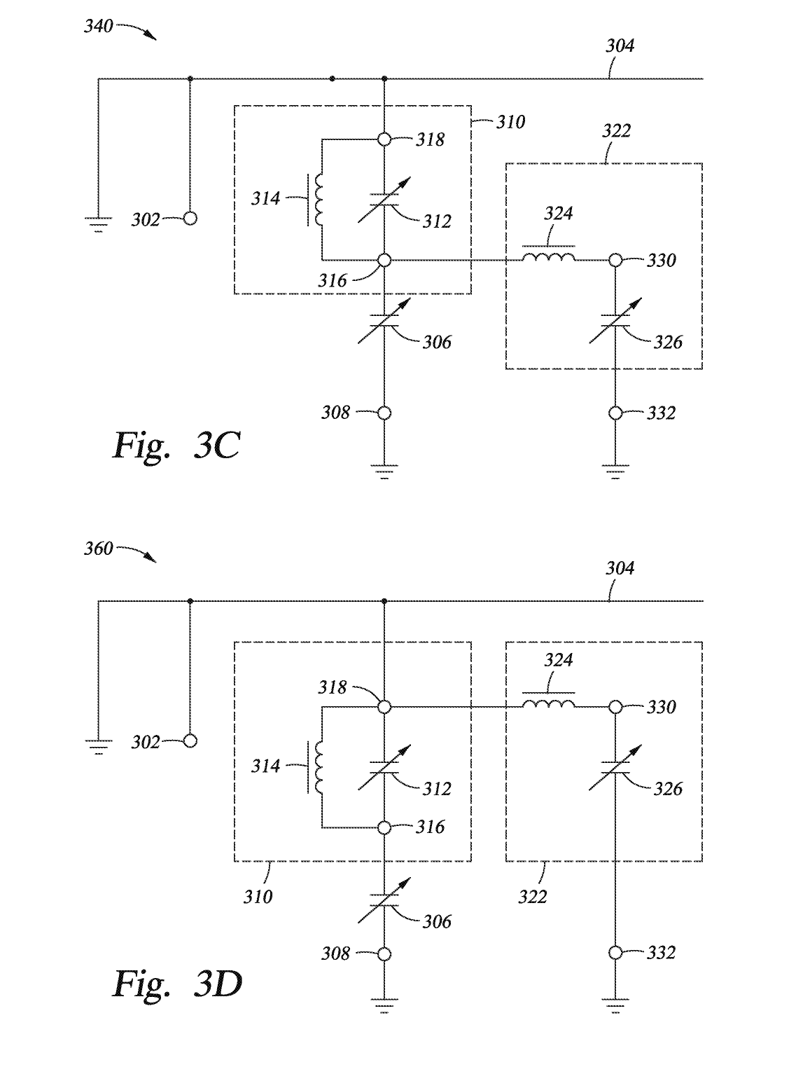

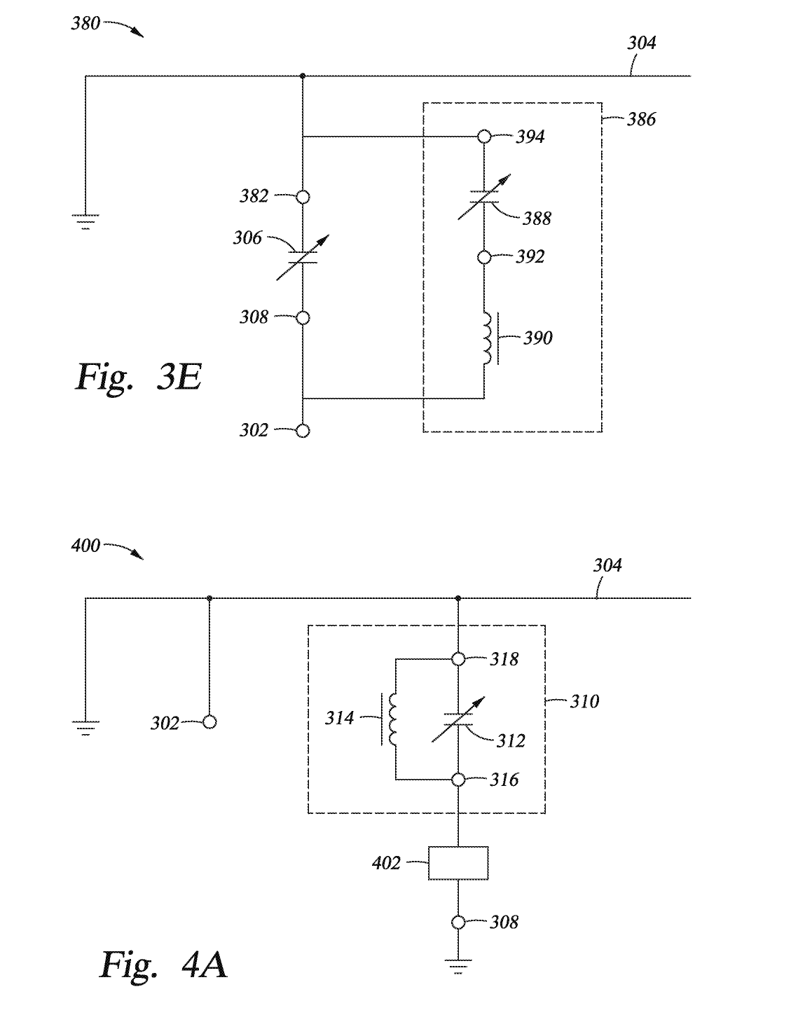

FIGS. 3A-3D are schematic circuit diagrams of the device containing the variable frequency filter according to several embodiments. The device may be the mobile phone of FIG. 1. FIG. 3A shows device 300 including an RF feed represented by node 302 and an antenna 304. The DVC 306 is electrically coupled to the antenna 304 and to ground through node 308. A suitable DVC that may be utilized is a DVC available from Cavendish Kinetics, Inc., San Jose, Calif. It is to be understood that other variable capacitors, such as those sold by other manufacturers, may be used as well.

In FIG. 3A, the variable frequency filter 310 is disposed between the antenna 304 and the DVC 306. The variable frequency filter 310 includes an LC circuit that includes a capacitor 312 and an inductor 314 connected in parallel between nodes 318 and 316. The DVC 306 is connected between nodes 316 and 308. The capacitor 312 may comprise a DVC that is separate and distinct from the DVC 306. Alternatively, the capacitor 312 may comprise a fixed SMT component. The variable capacitor 312 and the DVC 306 may each or either be shunted.

The DVC 306 is the primary DVC for the antenna aperture tuning. The filter 310 rejects harmonic frequencies. The inductor 314 may be fabricated on the printed circuit board of the device or as a fixed SMT component. In operation, the signal from the antenna 304 passes through the filter 310 and the DVC 306. The DVC 306 may generate a harmonic within a receiving band, such as the second or third harmonic, thereby causing the undesired harmonic to pass back towards the antenna 304. However, the filter 310 can reflect the undesired harmonic back towards the DVC 306. The filter 310 can be tuned to reflect a specific harmonic as desired. For example, the second and third harmonics may be undesirable for reaching the antenna 304. Furthermore, the filter can prevent receiving bands from passing to the DVC 306 from the antenna 304.

In the embodiment shown in FIG. 3B, the device 320 includes a filter 322 connected between nodes 328 and 332 while the DVC 306 is between nodes 328 and 308. The filter 322 includes an inductor 324 connected in series through node 330 to capacitor 326. Similar to capacitor 312 above, the capacitor 326 may be a fixed SMT capacitor, a variable capacitor, or a DVC that is separate and distinct from DVC 306. The filter 322 operates in parallel with the DVC 306 as opposed to in series, which is shown in FIG. 3A. The filters 310, 322 are used to isolate the undesired harmonics produced by the DVC 306 from the antenna 304,

It is contemplated that multiple filters may be present. FIGS. 3C and 3D each show embodiments where both filter 310 and filter 322 are present for devices 340, 360 respectively. In FIG. 3C, the second filter 322 is connected to node 316 between the first filter 310 and the DVC 306. In FIG. 3D, the second filter 322 is connected between the antenna 304 and filter 310.

FIG. 3E shows a device 380 in which the filter 386 is connected in parallel with the DVC 306. The filter 386 includes an inductor 390 and a capacitor 388 that are connected in series. The capacitor is connected between two nodes 394. 392. The DVC 306 is connected another node 382.

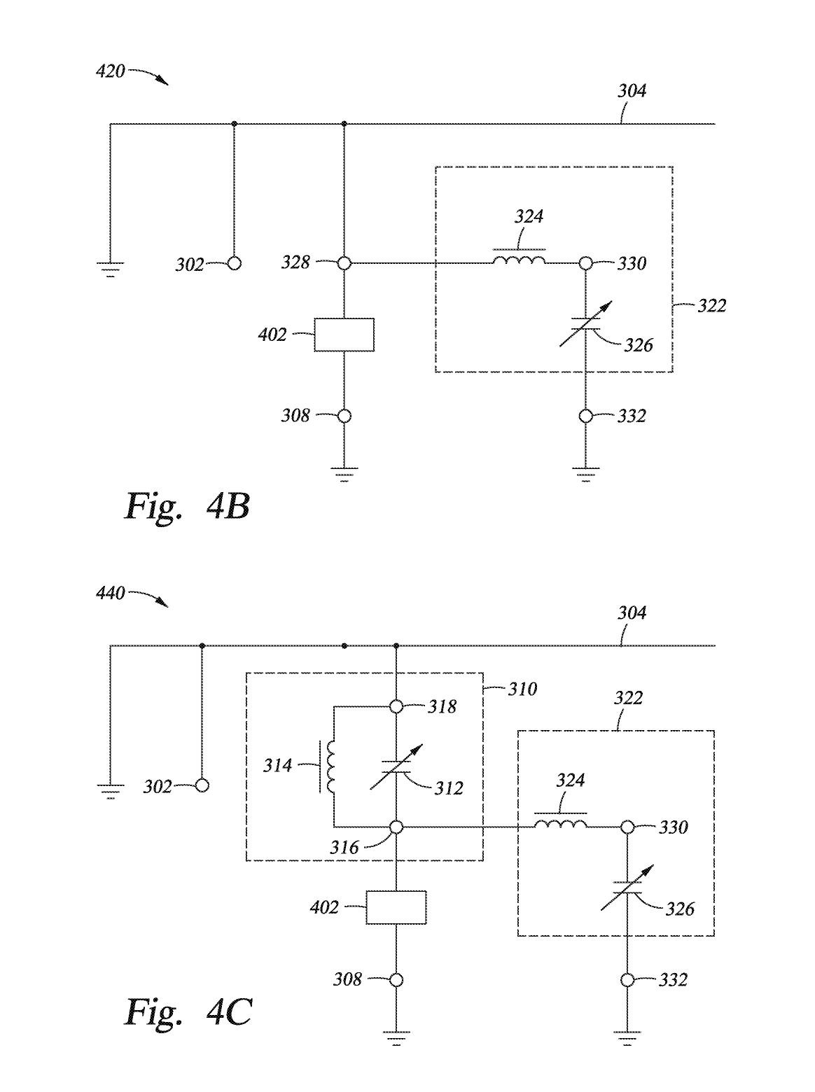

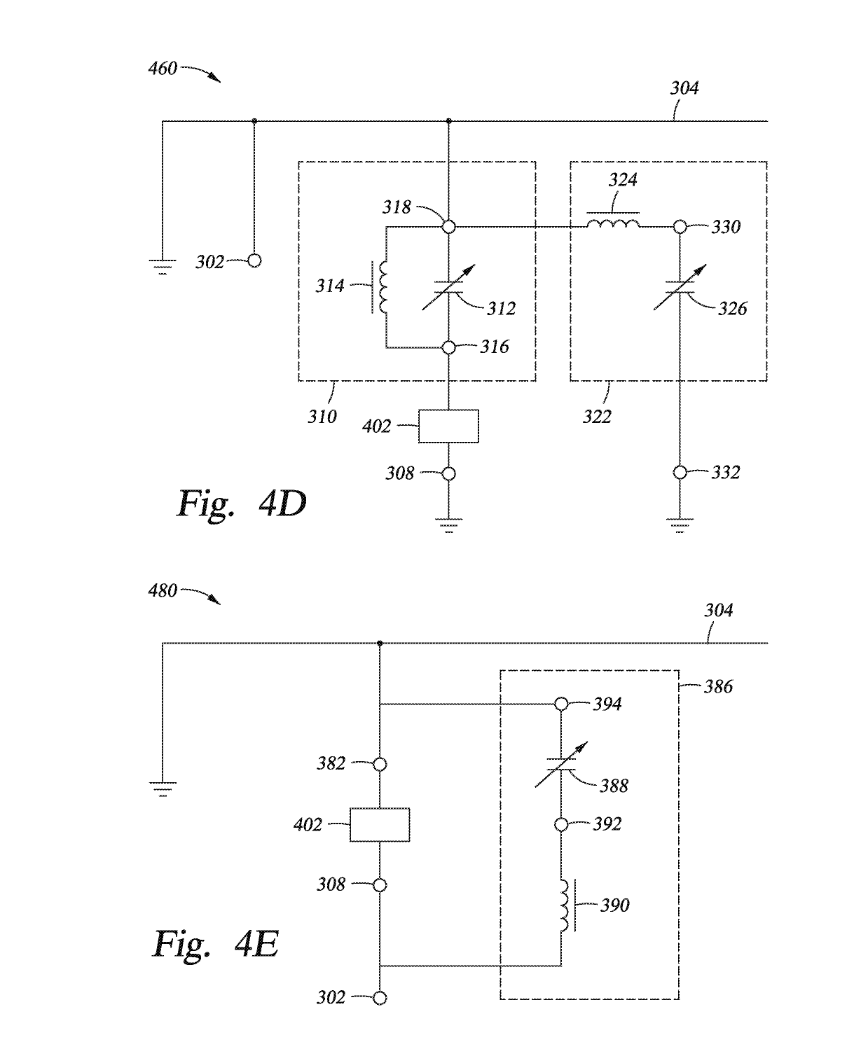

FIGS. 4A-4E are schematic circuit diagrams of the device containing a variable frequency filter according to several additional embodiments. FIGS. 4A-4E are identical to the devices 300, 320, 340, 360, 380 shown in FIGS. 3A-3E, except that the devices 400, 420, 440, 460, 480 replace the DVC 306 with a variable reactance device 402. In one embodiment, the variable reactance device 402 may comprise a DVC 306.

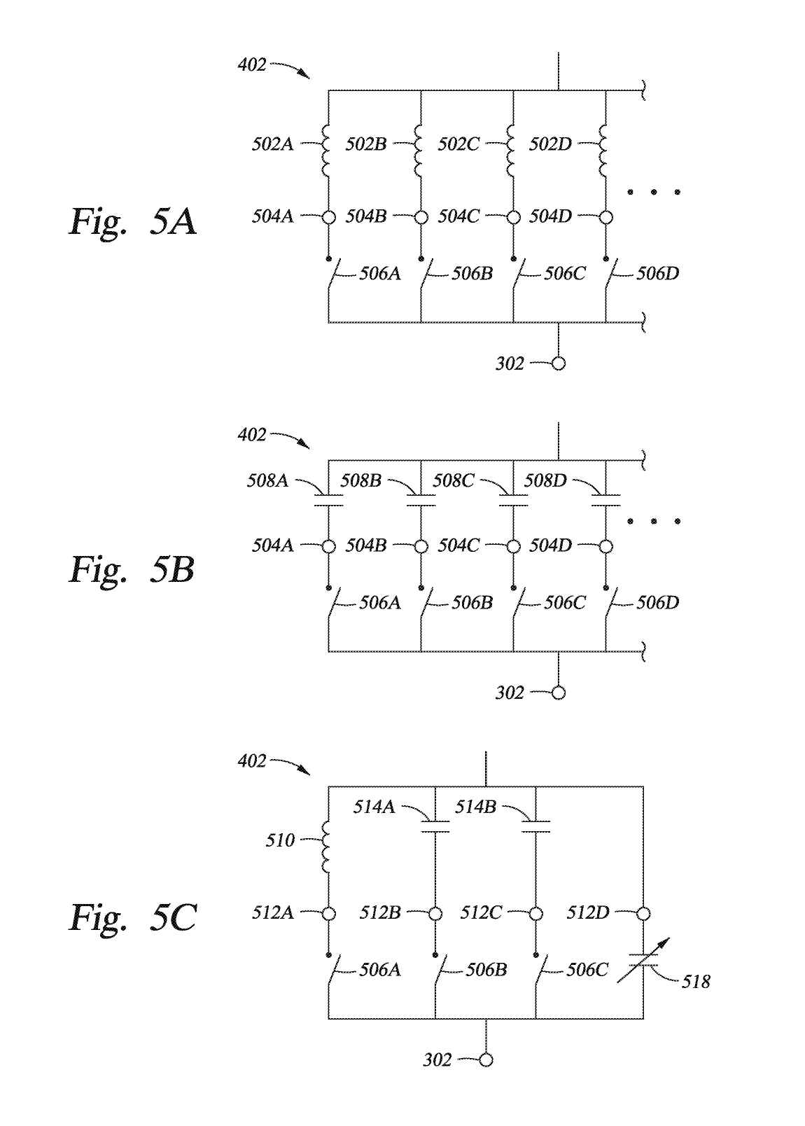

FIGS. 5A-5C are schematic illustrations of a variable reactance device 402 according to several embodiments. FIG. 5A illustrates a switched inductor that may be used as the variable reactance device 402. The switched inductor includes one or more inductors 502A-502D that are connected in parallel. It is to be understood that while four inductors 502A-502D are shown, as few as one and as many inductors as desired may be utilized. Each inductor 502A-502D is connected to a node 504A-504D and a switch 506A-506D in series. The switches 506A-506D are coupled to node 302.

FIG. 5B illustrates a switched capacitor that may be used as the variable reactance device 402. The switched capacitor includes one or more capacitors 508A-508D that are connected in parallel. It is to be understood that while four capacitors 508A-508D are shown, as few as one and as many capacitors as desired may be utilized. Each capacitor 508A-508D is connected to a node 504A-5040 and a switch 506A-506D, The switches 506A-506D are coupled to node 302.

FIG. 5C illustrates a variable reactance device 402 that includes a mix of switched inductors, switched capacitors and variable capacitors. The inductor 510 is connected to a node 512A, and the capacitors 514A, 514B are also connected to nodes 512B, 512C. Each node 512A-512C is connected to a switch 516A-516C. A variable capacitor 518 is also present and coupled to a node 5120. The variable capacitor 518, which may be a DVC, is coupled to node 302 without a switch therebetween whereas the inductor 510 and capacitors 514A, 514B are coupled to the node 302 through switches 516A-516C. It is to be understood that while a single switched inductor, two switched capacitors, and a single variable capacitor 518 are shown, any combination of switched inductors, switched capacitors and variable capacitors, in any numerical amount, may be utilized as desired.

It is also contemplated that transmitting signals coming from a second transmitter may also be reflected, The signals from the second transmitter are present on the same antenna and are reflected so as to not reach DVC 306. Thus, the filter operates to protect the DVC 306 from signals generated from multiple transmitters that exist on the same antenna.

It is to be understood that while a single antenna 304 is shown, multiple antennas may be present and each antenna 304 may have a similar filter or different filter. Additionally, the DVC 306, variable reactance device 402 and the capacitors 312, 326 may be independently tuned. Collectively, the DVC 306 and filter (or variable reactance device 402 and filter) may be tuned to reflect undesired harmonics from reaching the antenna. Because the DVC 306, variable reactance devices 402 and filters are tunable, the antenna may be used across many bands and hence, be adaptable to almost any network. In other words, the tenability of the DVC 306 and the filter (or variable reactance device 402 and filter) permit a mobile phone to be a ‘world phone’ that can easily switch between signals and thus, operate in any country at almost any setting,

While the foregoing is directed to embodiments of the present disclosure, other and further embodiments of the disclosure may be devised without departing from the basic scope thereof, and the scope thereof is determined by the claims that follow.

1. A device, comprising:
a first antenna;
an RF source coupled to the first antenna;
a variable reactance device coupled to the first antenna; and
a first variable frequency filter coupled to the first antenna and the variable reactance device.

2. The device of claim 1, wherein the variable reactance device is a digital variable capacitor.

3. The device of claim 2, wherein the digital variable capacitor includes a plurality of MEMS devices,

4. The device of claim 1, wherein the variable reactance device comprises one or more switched inductors.

5. The device of claim 1, wherein the variable reactance device comprises one or more switched capacitors.

6. The device of claim 1, wherein the variable reactance device comprises one or more of the following:
switched inductors;
switched capacitors; and
variable capacitors.

7. The device of claim 1, wherein the first variable frequency filter comprises a first inductor and a first capacitor.

8. The device of claim 7, wherein the first inductor and the first capacitor are connected in parallel.

9. The device of claim 8, further comprising a second variable frequency filter coupled between the variable reactance device and the first antenna.

10. The device of claim 9, wherein the first variable frequency filter is connected between a first node and a second node and wherein the variable reactance device is connected to the second node.

11. The device of claim 10, wherein the second variable frequency filter is connected to the second node.

12. The device of claim 11, wherein the second variable frequency filter includes a second inductor and a second capacitor.

13. The device of claim 12, wherein the second inductor and second capacitor are connected in series.

14. The device of claim 10, wherein the second variable frequency filter is connected to the first node.

15. The device of claim 14, wherein the second variable frequency filter includes a second inductor and a second capacitor.

16. The device of claim 15, wherein the second inductor and second capacitor are connected in series.

17. The device of claim 7, wherein the first inductor and the second capacitor are connected in series.

18. The device of claim 1, wherein the device is a mobile phone.

19. The device of claim 1, further comprising:
a second antenna coupled to the RF source, wherein the second antenna is separate and distinct from the first antenna;
a second variable reactance device coupled to the second antenna; and
a second variable frequency filter coupled to the second antenna and the second capacitor.

20. The device of claim 19, wherein the first variable frequency filter and the second variable frequency filter each comprise an inductor and a capacitor and wherein the inductor and capacitor are connected either in series or in parallel,

21. The device of claim 20, wherein the inductor and capacitor of the second variable frequency filter are connected in series and the inductor and capacitor of the first variable frequency filter are connected in parallel.

22. The device of claim 20, wherein the inductor and capacitor of the second variable frequency filter are connected in parallel and the inductor and capacitor of the first variable frequency filter are connected in parallel.

23. The device of claim 20, wherein the inductor and capacitor of the second variable frequency filter are connected in series and the inductor and capacitor of the first variable frequency filter are connected in series.
